(19) United States
(12) Patent Application Publication
(10) Pub. No.: US 2009/0066719 A1
(43) Pub. Date: Mar. 12, 2009

(54) IMAGE DITHERING BASED ON FAREY FRACTIONS

(75) Inventor: Michel Combes, San Leandro, CA (US)

Correspondence Address: FISH & RICHARDSON P.C., PO BOX 1022, MINNEAPOLIS, MN, 55440-1022, US

(73) Assignee: SPATIAL PHOTONICS, INC., Sunnyvale, CA (US)

(21) Appl. No.: 11/851,790

(22) Filed: Sep. 7, 2007

(51) Int. Cl. G09G 5/02

(52) U.S. Cl. 345/596

(57) ABSTRACT

A method for image processing includes quantizing pixel values of the first digital image to form a sequence of quantized pixel values each having the second bit depth. The step of quantizing the pixel values generates a sequence of least significant bit groups, each of the least significant bit groups including one or more least significant bits removed from an associated pixel value of the first digital image, The method also includes converting at least some of the least significant bit groups to binary values, the conversion of each least significant bit group using a binary representation of a fraction proportional to a value of the one or more least significant bits from the least significant bit group and adding the binary values to the quantized pixel values to produce the processed digital image.

### BACKGROUND

The present disclosure relates to display technologies, in particular, dithering of digital images to be displayed by display devices.

Contouring is a well known image artifact in image displays. Contouring can occur when a grayscale image is displayed by a display device capable of displaying a limited number of brightness levels. For example, when an image of a fruit is displayed, artificial contouring can appear at a high light area of the fruit, i.e., where light is reflected from the fruit, when the brightness level displayed by the display device discontinuously changes from one level to an adjacent level.

Dithering is a commonly image-processing technique for overcoming image contouring in the display images. Dithering works by adding noise to the pixel values of the digital image before the pixel values are quantized to the limited number of brightness levels that the display device is capable of displaying. Image dithering can make the contour lines wider and fuzzier, and thus minimize or eliminate the perception of image contours.

A typical dithering technique stores a two dimensional noise matrix in a display device. The noise matrix can include white noise or blue noise. To prepare a digital image for display, the noise matrix is mapped to the digital image and the noise values in the noise matrix are added to the pixel values in the digital image. The dithered digital image is then quantized to the brightness levels of the display device to allow it to be displayed. Such dithering technique may have several disadvantages such as, requiring the storage of a noise matrix in a storage device, being computationally intensive, and adding artificial noise to the display image.

### SUMMARY OF THE INVENTION

In a general aspect, a method for image processing is described that includes quantizing pixel values of a first digital image to form a sequence of quantized pixel values each having a second bit depth. The step of quantizing the pixel values generates a sequence of least significant bit groups, each of the least significant bit groups including one or more least significant bits removed from an associated pixel value of the first digital image, The method also includes converting at least some of the least significant bit groups to binary values, the conversion of each least significant bit group using a binary representation of a fraction proportional to a value of the one or more least significant bits from the least significant bit group and adding the binary values to the quantized pixel values to produce the processed digital image.

In another general aspect, a computer program product encoded on a tangible program carrier, operable to cause data processing apparatus to perform operations is described. The operations include quantizing pixel values of the first digital image to form a sequence of quantized pixel values each having the second bit depth, wherein quantizing the pixel values generates a sequence of least significant bit groups, each of the least significant bit groups including one or more least significant bits removed from an associated pixel value of the first digital image; converting at least some of the least significant bit groups to binary values, the conversion of each least significant bit group using a binary representation of a fraction proportional to a value of the one or more least significant bits from the least significant bit group; and adding the binary values to the quantized pixel values to produce the processed digital image.

In another general aspect, a method for image processing is described. The method includes quantizing pixel values of the first digital image to form a sequence of quantized pixel values each having the second bit depth, wherein quantizing the pixel values generates a sequence of least significant bit groups, each of the least significant bit groups including one or more least significant bits removed from an associated pixel value of the first digital image; converting at least some of the least significant bit groups to binary values, the conversion of each least significant bit group using a binary representation of a fraction proportional to a value of the one or more least significant bits from the least significant bit group; and adding the binary values to the quantized pixel values to produce the processed digital image.

In another general aspect, a method for processing a data string is described. The method includes quantizing binary numbers in a first data string to form a quantized data string and a second data string that is a difference between the first data string and the quantized data string; converting a first binary number in the second data string to a first transformed binary number using a binary representation of a fraction proportional to the first binary number; and sequencing bit values of the first transformed binary number to form a first segment of a third data string.

Implementations of the system may include one or more of the following. The fraction used in converting the least significant bit groups to a binary value can have a numerator equal to a value of the least significant bit and a denominator equal to 2^{x}, where x is number of digits in the least significant bits. The fraction can belong to a Farey Sequence M and the binary representation can comprise a concatenation of binary representations of neighboring fractions from at least one of the Farey sequences 0 through M−1, wherein M is a positive integer. The image processor can convert at least some of the least significant bit groups to a map of binary values using binary representations of fractions each proportional to the value of the corresponding least significant bits and to add the map of binary values to the quantized pixel values to produce the processed digital image. The image processor can further define a path through a plurality of pixels in the first digital image; map a first least significant bit group associated with a first pixel in the path to a binary representation of a fraction corresponding to the first least significant bit group; and successively assign bit values of the binary representation to a first sequence of corresponding pixels along a corresponding path to produce the map of binary values. The image processor can further select a starting pixel for the path. The path can be a serpentine pattern or a Peano-Hilbert pattern in the first digital image. The path can pass through all the pixels in the first digital image. The display system can further include a display device configured to display the rendered digital image, wherein the display device comprises a liquid crystal display (LCD), a light emitting diode display (LED), an organic light emitting diode (OLED) display, a laser diode display, a projection display using a spatial light modulator, or a display device comprising a tiltable micro mirror.

Embodiments may include one or more of the following advantages. The disclosed dithering technique can require less computation than some conventional dithering techniques. The image dithering can be applied to an input digital image on the fly without using a previously stored noise matrix. The simple rules can also allow the disclosed dithering technique to be flexibly applies to image dithering for a wide range of display devices. Furthermore, the disclosed dithering method does not add white noise to the input digital image, which can avoid a snowy effect in dithered images produced by some convention dithering techniques that require additional white noise.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and from a part of the specification, illustrate embodiments of the present specification and, together with the description, serve to explain the principles of the specification.

FIG. 1 is a block diagram of a display system.

FIG. 2 is a flow chart for image dithering based on Farey fractions in accordance with the present specification.

FIG. 3A illustrates the separation of an input digital image into a quantized digital image having a bit depth equal to the display bit depth and a digital image having the remaining one or more least significant bits.

FIG. 3B illustrates the digital image having the remaining one or more least significant bit(s).

FIG. 3C illustrates the conversion of the least significant bits of the pixel values into fractions in the digital image of FIG. 3B.

FIGS. 3D and 3E illustrate exemplified paths in the digital image for converting the pixels in the digital image into a pixel string.

FIG. 3F illustrates the formation of a dither map after the fractions in the pixel string are mapped to binary values for a first exemplified start pixel in the pixel string.

FIG. 3G illustrates the formation of a dither map after the fractions in the pixel string are mapped to binary values for another exemplified start pixel in the pixel string.

FIG. 3H illustrates the formation of dithered digital image by adding the dither map to the quantized digital image.

FIG. 4 illustrates the conversion of a fraction data string containing Farey fractions to a binary data string using binary representations of Farey fractions.

FIG. 5 illustrates a Farey tree including Farey fractions and their associated binary representations.

### DETAILED DESCRIPTION

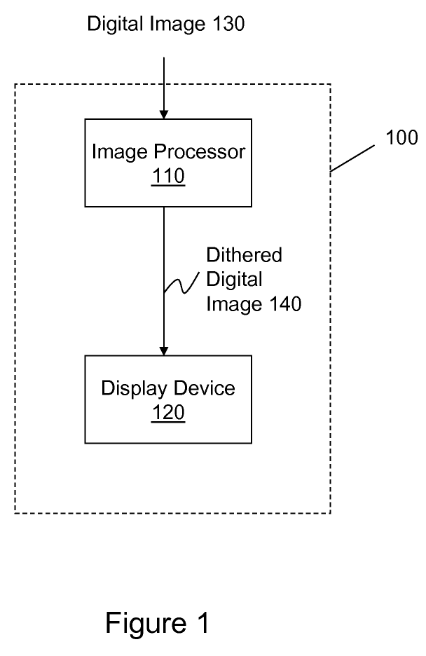

Referring to FIG. 1, a display system 100 includes an image processor 110 and a display device 120. The display system 100 receives an input digital image 130 at a first bit depth. The image processor 110 can conduct several image rendering operations, which can include image dithering. The display device 120 can display images at a second bit depth less than the first bit depth. The image processor 110 dithers the digital image 130 to generate a dithered image 140 at the second bit depth. The display system 100 can be implemented in a stand alone integrated device or separate devices including the image processor 110 and the display device 120.

For the purpose of discussion, it is assumed that in an exemplary display system the digital image 130 has a bit depth of 6 bits and the display device 120 has a display bit depth of 4 bits. The digital image 130 thus needs to be quantized from 6 bits to 4 bits during image dithering for the dithered digital image 140 to be displayed by the display device 120. Of course, other bit depths are possible.

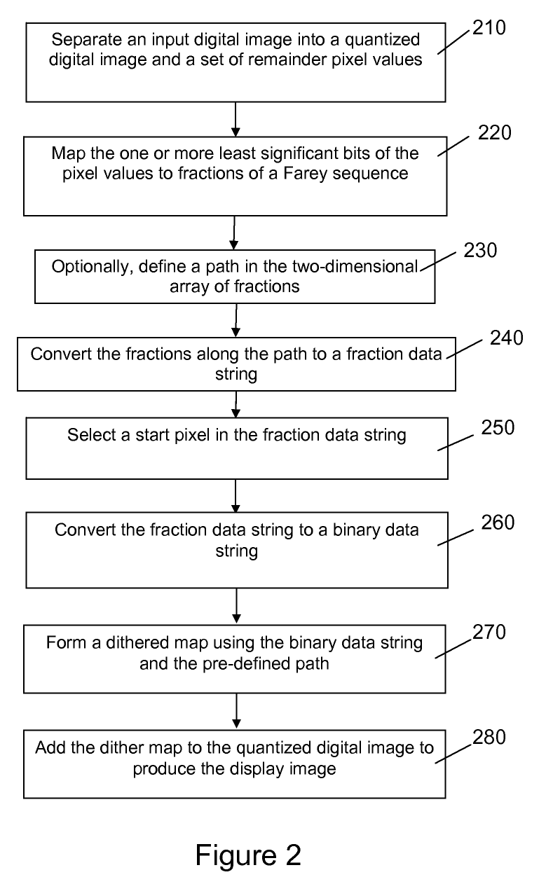

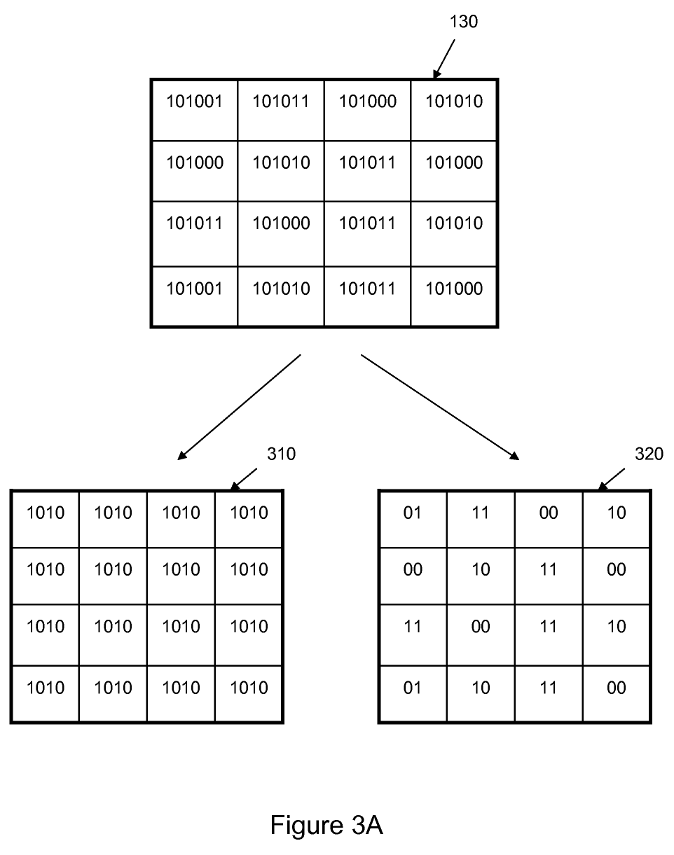

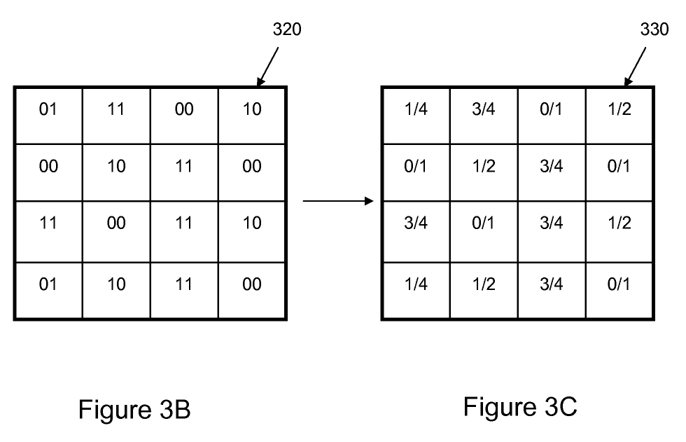

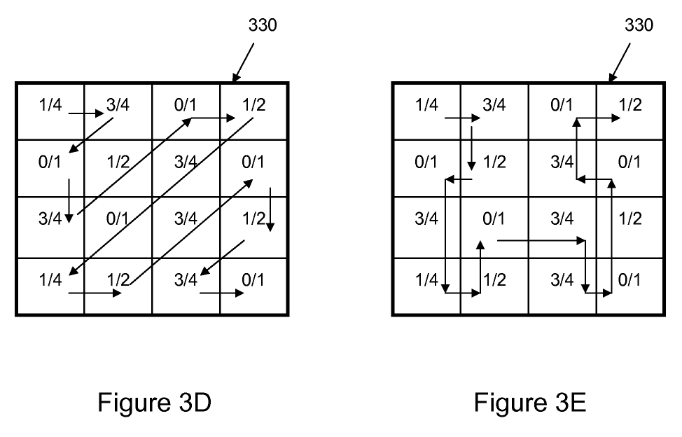

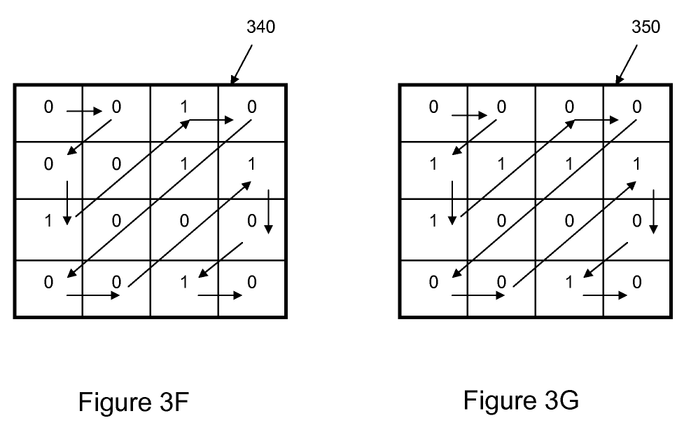

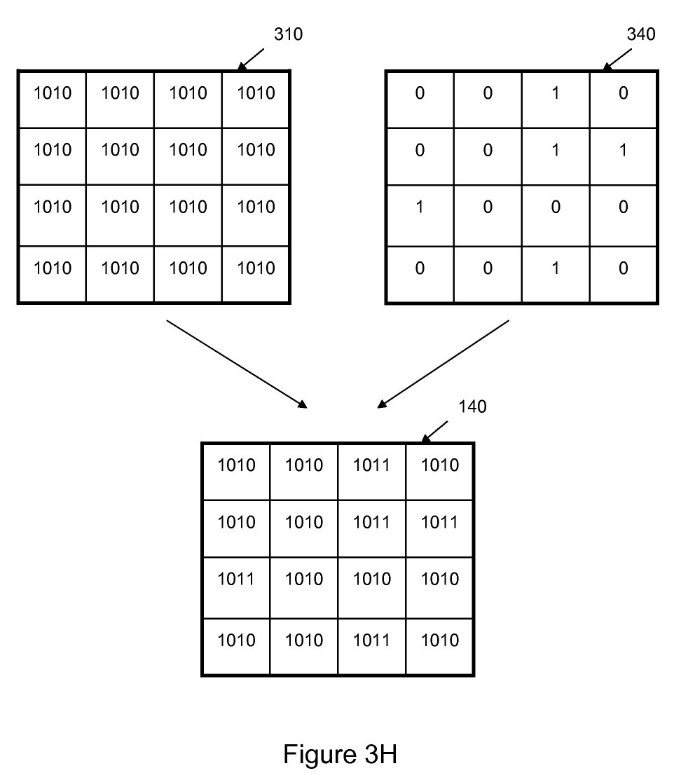

Referring to FIGS. 2 and 3A-3H, the pixel values of the digital image 130 are separated into a quantized digital image 310 having the most significant bits equal to display bit depth and a set of remainder pixel values 320 having the remaining one or more least significant bits (step 210). Quantizing the pixel values constrains the number of bits in the value to the most significant, thereby removing the least significant bits. In some embodiments, the display bit depth sets a fix bit depth (less than the bit depth of the digital image 130) for producing a quantized digital image 310. In other words, the pixel values in the set of remainder pixel values 320 are the differences between the pixel values in the digital image 130 and the quantized pixel values in the quantized digital image 310. Since in the example the display bit depth is four bits, the quantized digital image 310 thus has the four most significant bits of the digital image 130; the set of remainder pixel values 320 has the remaining two least significant bits. For example, the pixel value “101001” in the upper left corner of the digital image 130 is parsed into a four bit binary data string of “1010” (the most significant bits) and a two bit binary data string of “01” (the least significant bits). For clarity, the values of the four most significant bits of the digital image 130 shown in FIG. 3A are assumed to have a uniform binary value of “1010”. Optionally, the set of remainder pixel values 320 are ordered in the two-dimensional array corresponding to the array of pixels in the digital image 130. The two-dimensional array is described further herein below. In some embodiments, a remainder pixel value 320 is generated for each pixel in the digital image 130. However, in other embodiments, remainder pixel values 320 are generated for less than or equal to all of the pixels in the digital image 130, e.g., only for those remainder pixel values whose binary strings will be added to the quantized digital image (in step 280).

Next, as shown in FIGS. 3B and 3C, the pixel values in the set of remainder pixel values 320 are mapped to fractions in a Farey sequence to form a sequence (optionally, a two-dimensional array 330) of fractions (step 220). Each fraction is proportional to the associated remainder pixel value from which the fraction is mapped. The number of combinations of least significant bits is equal to the denominator. For example, in a two bit binary string, there are four possible combinations of binary numbers. Therefore, four is the denominator. More generally, for x least significant bits, the denominator is 2̂x. In contrast, the value of the least significant bits defines the numerator. For the example, the four possible binary numbers in increasing order are “00”, “01”, “10” and “11”. If the denominator is m, the numerators are integers, 0 through (m−1). The four fractions start with 0, and therefore are 0/4, ¼, 2/4 and ¾, respectively. The number 1 is not used as a denominator. Thus, 00 corresponds to 0/4, 01 corresponds to ¼, 10 corresponds to 2/4 and 11 corresponds to ¾. The least significant bit of the quantized digital image 310 can be viewed as a threshold value for the quantization of the digital image 130 as well as the computation of fraction values for the pixels in the set of remainder pixel values 320. In some embodiments, a fraction is generated for each remainder pixel value 320. However, in other embodiments, a fraction is generate for less than all remainder pixel values 320, e.g., only for those fractions whose binary strings will be added to the quantized digital image (in step 280).

If the set of remainder pixel values 320 are in a two-dimensional array, a path is next defined in the two-dimensional array 330 of pixels that passes through all the elements in the two-dimensional array 330 (step 230). The path passes each element in the two-dimensional array 330 exactly once. The path can include straight segments and turns. The path can exist in different patterns: for example, a diagonal serpentine pattern, as shown in FIG. 3D; a Peano-Hilbert pattern as shown in FIG. 3E; or a horizontal serpentine pattern (not shown). The path can be continuous and fill the two-dimensional array 330. In some embodiments, the two-dimensional array 330 can be separated into different areas that each can be covered by a continuous path (the path through the entire two dimensional array 330 can include discontinuities). The fractions along the path can be converted to a fraction data string for the two-dimensional array 330 (Step 240). For example, the two-dimensional array 330 having the path in FIG. 3D defines a fraction data string of “¼, ¾, 0/1, ¾, ½, 0/1, ½, ¾, 0/1, ¼, ½, ¾, 0/1, ½, ¾, 0/1”. If the sequence of fractions is not in a two-dimensional array, then the sequence defines the path.

A first start pixel is selected in the fraction data string (step 250) to prepare for the mapping to fractions. In some embodiments, the first start pixel is the first pixel in the fraction data string (i.e., the first pixel from the left in the top row, shown in FIG. 3D). We thus have the data string starting from “¼”: “¼, ¾, 0/1, ¾, ½, 0/1, ½, ¾, 0/1, ¼, ½, ¾, 0/1, ½, ¾, 0/1”.

Next, at least some of the fractions are converted to binary representations, in particular, binary representations of fractions in a Farey sequence. In some embodiments, a binary representation is generated for each fraction 320. However, in other embodiments, a binary representation is generate for less than all of the fractions 320, e.g., only for those fractions whose binary representations will be added to the quantized digital image (in step 280).

In particular, the fraction at the start pixel is converted to a binary representation of the fraction (step 260). Each of binary bit values in the binary representation is used to replace (or overwrite) the fractions immediately following the start pixel in the fraction data string. The binary bit values thus form a first segment of a binary data string. The fraction immediately following the first segment of a binary data string is then defined as the next start pixel. The above described steps are repeated to produce a second segment of binary bit values in the binary data string. The steps are repeated until each pixel has a binary bit value.

In mathematics, a Farey sequence is a series of fractions with values from 0 (denoted as 0/1) to 1 denoted as 1/1), arranged in order of increasing size. Farey sequences can include different orders such as F1, F2, F3, . . . and so on. The Farey sequences of orders 1 to 8 are as follows:

F1={ 0/1, 1/1}

F2={ 0/1, ½, 1/1}

F3={ 0/1, ⅓, ½, ⅔, 1/1}

F4={ 0/1, ¼, ⅓, ½, ⅔, ¾, 1/1}

F5={ 0/1, ⅕, ¼, ⅓, ⅖, ½, ⅗, ⅔, ¾, ⅘, 1/1}

F6={ 0/1, ⅙, ⅕, ¼, ⅓, ⅖, ½, ⅗, ⅔, ¾, ⅘, ⅚, 1/1}

F7={ 0/1, 1/7, ⅙, ⅕, ¼, 2/7, ⅓, ⅖, 3/7, ½, 4/7, ⅗, ⅔, 5/7, ¾, ⅘, ⅚, 6/7, 1/1}

F8={ 0/1, ⅛, 1/7, ⅙, ⅕, ¼, 2/7, ⅓, ⅜, ⅖, 3/7, ½, 4/7, ⅗, ⅝, ⅔, 5/7, ¾, ⅘, ⅚, 6/7, ⅞, 1/1}

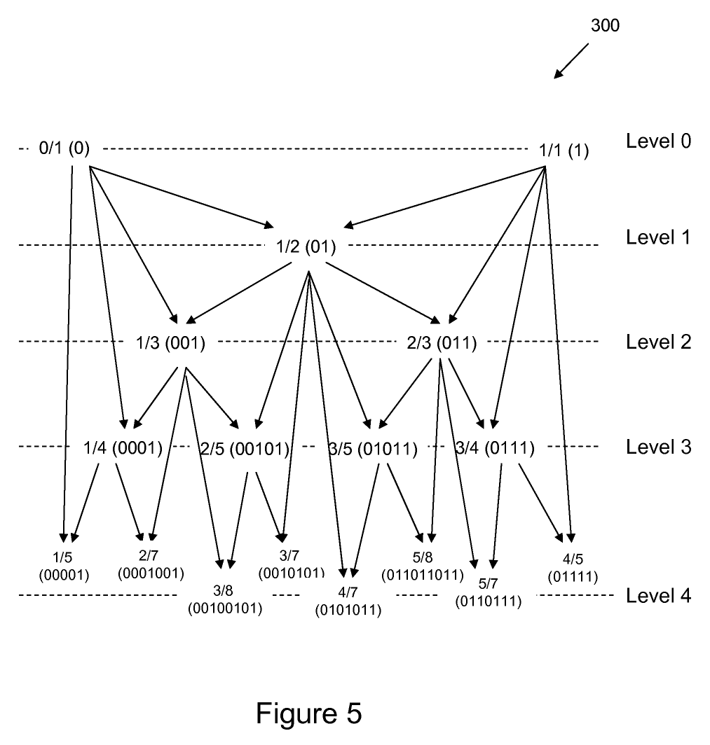

The Farey sequences can be derived by fractions at different levels. As shown in FIG. 5, fractions include 0/1 and 1/1 at Level 0 (F1); ½ at Level 1 (F2); ⅓ and ⅔ at Level 2 (F3), and so on. F1 includes the fractions from Level 0. F2 includes the fractions from Level 0 and Level 1. F3 includes the fractions from Level 0 through Level 2. F4 includes the fractions from Level 0 through Level 3, and so on.

A fraction in a Farey sequence can be determined by the two neighboring fractions at levels above that fraction. If a/b and c/d are neighbors in a Farey sequence, then the fraction that appears between them in the next order Farey sequence is (a+c)/(b+d). For example, the term in F5 that appears between ⅓ (of F3) and ¼ (of F4) is (1+1)/(3+4)= 2/7, as shown in FIG. 5.

Each fraction can be associated with a binary representation (shown in the parenthesis next to each fraction in FIG. 5). The binary representations for 0/1 and 1/1 are respectively 0 and 1. In some embodiments, the binary representation of a fraction can be a binary string combining the binary representations of the two fractions that the fraction is associated with. For example, the binary representation for the fraction ½ can be obtained by simply combining “0” and “1”.

In some embodiments, combining the binary representations of two numbers concatenates the representation for the larger fraction onto the end of the binary representation for the smaller fraction. In another example, 4/7 is the fraction between ⅗ and ½. The binary representation for 4/7 is (0101011), which is the combination of (01) and (01011), which are the binary representations for ½ and ⅗. Thus, as used herein, the “binary representation of a fraction in a Farey sequence” means the binary string that would be generated for a fraction using the aforementioned process.

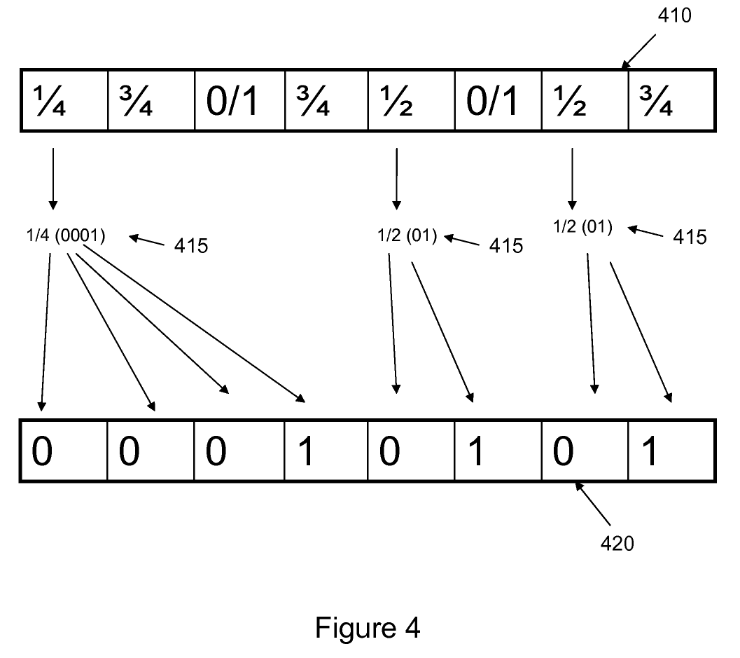

Referring back to FIGS. 2, 3A-3H, the fraction data string in the two-dimensional array 330 is converted to a binary data string using binary representations of the fractions. As noted above, a path can be mapped through the array of pixel values, the least significant bit string is converted to a fraction, a corresponding converted binary string is found for the fraction, each bit of the converted binary string is assigned to a pixel along the path and at the next pixel along the path, the conversion steps and assignment step are performed again. For example, the fraction data string “¼, ¾, 0/1, ¾, ½, 0/1, ½, ¾, 0/1, ¼, ½, ¾, 0/1, ½, ¾, 0/1” is mapped to binary data string “0, 0, 0, 1, 0, 1, 0, 1, 0, 0, 0, 0, 1, 0, 1, 0” that has a length equal to the length of the fraction data strong, as shown in FIG. 3F. Details of the conversion are shown in FIG. 4. The first fraction “¼” in the fraction data string 410 is selected as the start pixel. The binary representation 415 of the fraction ¼ is (0001). The four binary bits of (0001) are copied to the first four binary numbers in the binary data string 420. For the next available bit in the binary data string, the fraction in the corresponding position in the fraction data string is determined.

Each digit of the fraction data string corresponds to a pixel. Because fraction data strings can have more than one digit, the pixels that are filled by a binary representation of a preceding fraction are “overwritten”, e.g., ignored. This provides some of the dithering. In this example, the fractions in the second to the fourth positions are simply “overwritten” by the start pixel selected (first left pixel in the top row) and thus their data is not used in the resulting binary data string.

In the fraction data string 410, the fraction “½” is the fifth element following a string of four fractions. Then binary representation (01) for “½” is appended to the binary data string 420. This process iterates until the binary data string reaches the desired length, e.g., equal to the number of pixels. The fifth fraction in the fraction data string is “½”, which has a binary representation of “01” in a Farey sequence. Thus “01” are copied to the fifth and sixth binary numbers in the binary data string 420. The fraction in the sixth position is “overwritten” by the binary data of the fraction in the fifth position. This mapping process is repeated until the binary data string reaches the desired length, e.g., equal to the number of pixels. As a result, the binary data string 420 “0, 0, 0, 1, 0, 1, 0, 1, 0, 0, 0, 0, 1, 0, 1, 0” is produced. The ID binary data string “0, 0, 0, 1, 0, 1, 0, 1, 0, 0, 0, 0, 1, 0, 1, 0” is mapped back to form a dither map 340 (see FIG. 3H) using the same diagonal serpentine path that was used to produce the fraction data string (step 270 of FIG. 2).

The binary data string 420 provides the dithered pixel values produced by image dithering. The dither map 340 is added to the quantized digital image 310 to produce the dithered digital image 140 (step 280), as shown in FIG. 3H. Here, the binary data string 420 produced by the sequence of converting and assigning are added to the pixel values in the to pixel values in the quantized digital image 310 to obtain the pixel values of a dithered digital image. The dithered digital image 140 can be subsequently displayed by the display device 120.

For video displays, the digital image 130 can be one image frame followed by other image frames. In some embodiments, different start pixels can be selected in the fraction string for different image frames in video display. For example, for the image frame next to the digital image 130, the start pixel can be the second fraction in the fraction data string (i.e., the second pixel from the left in the top row in FIG. 3D). We thus have the data string starting from “¾”: “¾, 0/1, ¾, ½, 0/1, ½, ¾, 0/1, ¼, ½, ¾, 0/1, ½, ¾, 0/1”. When the fractions are converted to binary values, the first fraction “¼” in the upper left pixel can be quantized to have “0” binary value. The fractions in “¾, 0/1, ¾, ½, 0/1, ½, ¾, 0/1, ¼, ½, ¾, 0/1, ½, ¾, 0/1” can be converted to binary values using the Farey binary representations as described above. “¾” is converted to “0111”; “ 0/1” is converted to “0”; “½” to “01”, and so on, to obtain a binary data string “0, 1, 1, 1, 0, 0, 1, 0, 0, 0, 0, 1, 0, 1, 0”. The first binary number can simply be a rounded whole number for the first fraction. In some embodiments, a threshold is set, such as ½, to determine whether a pixel is assigned a 0 or 1. Thus, the first fraction “¼” is rounded off to be “0” since it is less than ½. In some embodiments, if the first starting least significant bit is not in the upper left corner of the image, the path wraps around to the beginning of the set of values in the string of least significant bits.

The binary data string is then mapped to form a dither map 350 as shown in FIG. 3G. The dither map can then be added to the quantized digital image 310 to produce the dithered image 140. The selection of different start pixels in the two-dimensional array 330 can allow different pixels to have their least significant bits to be represented in the dither map for different image frames.

In lieu of performing all of the steps described above, the least significant bits can be converted directly to a converted binary string by mapping the least significant bits to a stored set of values. The stored set of values can be based on the Farey sequence described above. This mapping allows the computations to be performed more quickly than performing a series of conversions. For example, if the least significant bit includes two places, there are four possible combinations of binary digits, 00, 01, 10 and 11. In this situation, the mapping relates the least significant bits directed to the converted binary string: 00 to 0, 01 to 0001, 10 to 01 and 11 to 0111 (see FIG. 5). In some embodiments, rather than converting every pixel to a fraction or a binary number, only the pixels that require conversion are converted, further speeding up the processing step. That is, the pixels are overwritten by a binary digit of a converted binary string from a preceding least significant bit conversion is not converted. Moreover, rather than determining least significant bits for each pixel, only the least significant bits for the pixels that require conversion need be determined. Combining these techniques allows for mapping a least significant bit to its converted binary string, assigning the digits in the converted binary string each to its own pixel and at the next available pixel iterating the sequence of steps with the next least significant bit.

The disclosed display device can include one or more of the following advantages. The disclosed dithering technique requires less computation than some conventional dithering techniques. The image dithering can be applied to an input digital image on the fly without using a previously stored noise matrix. The simple rules also allow the disclosed dithering technique to be flexibly applies to image dithering for a wide range of display devices, including micromirror devices with a small pitch. As the mirror pitch becomes smaller, the dithering, and use of fewer pixel values become less obvious to a viewer, that is, the image appears to have more continuous areas. Furthermore, the disclosed dithering method does not add white noise to the input digital image, which can avoid the snowy effect in dithered images produced by some convention dithering techniques that require additional white noise.

It is understood that the bit depth of the input digital image and the display bit depth described in the above examples are only meant for illustration purposes. The disclosed systems and methods are compatible with other combinations of bit depths. For example, an input digital image can have a bit depth of eight bits and the display image bit depth can be six bits.

The disclosed systems and methods are also compatible with other layouts of the paths for defining pixel strings and fraction data strings in a digital image. The disclosed systems and methods are compatible with a wide range of display technologies such as liquid crystal displays (LCD), light emitting diodes (LED) displays, organic light emitting diode (OLED) displays, laser diode displays, scanning displays, and projection displays using spatial light modulators (SLM) such as tiltable micro mirror arrays or liquid crystals on a semiconductor chip.

What is claimed is:

1. A display system, comprising:
an image processor configured to dither a first digital image having a first bit depth to produce a processed digital image having a second bit depth less than the first bit depth, wherein the image processor is configured to
quantize pixel values of the first digital image to form a sequence of quantized pixel values each having the second bit depth, wherein quantizing the pixel values generates a sequence of least significant bit groups, each of the least significant bit groups including one or more least significant bits removed from an associated pixel value of the first digital image;
convert at least some of the least significant bit groups to binary values, the conversion of each least significant bit group using a binary representation of a fraction proportional to a value of the one or more least significant bits from the least significant bit group; and
add the binary values to the quantized pixel values to produce the processed digital image.

2. The display system of claim 1, wherein the fraction used in converting the least significant bit groups to a binary value has a numerator equal to a value of the least significant bit and a denominator equal to 2^{x}, where x is number of digits in the least significant bits.

3. The display system of claim 1, wherein the fraction belongs to a Farey Sequence M and the binary representation comprises a concatenation of binary representations of neighboring fractions from at least one of the Farey sequences 0 through M−1, wherein M is a positive integer.

4. The display system of claim 1, wherein the image processor is configured to convert at least some of the least significant bit groups to a map of binary values using binary representations of fractions each proportional to the value of the corresponding least significant bits and to add the map of binary values to the quantized pixel values to produce the processed digital image.

5. The display system of claim 4, wherein the image processor is further configured to:
define a path through a plurality of pixels in the first digital image;
map a first least significant bit group associated with a first pixel in the path to a binary representation of a fraction corresponding to the first least significant bit group; and
successively assign bit values of the binary representation to a first sequence of corresponding pixels along a corresponding path to produce the map of binary values.

6. The display system of claim 5, wherein the image processor is further configured to select a starting pixel for the path.

7. The display system of claim 5, wherein the path comprises a serpentine pattern or a Peano-Hilbert pattern in the first digital image.

8. The display system of claim 5, wherein the path passes all the pixels in the first digital image.

9. The display system of claim 1, further comprising a display device configured to display the rendered digital image, wherein the display device comprises a liquid crystal display (LCD), a light emitting diode display (LED), an organic light emitting diode (OLED) display, a laser diode display, a projection display using a spatial light modulator, or a display device comprising a tiltable micro mirror.

10. A computer program product, encoded on a tangible program carrier, operable to cause data processing apparatus to perform operations comprising:
quantizing pixel values of the first digital image to form a sequence of quantized pixel values each having the second bit depth, wherein quantizing the pixel values generates a sequence of least significant bit groups, each of the least significant bit groups including one or more least significant bits removed from an associated pixel value of the first digital image;
converting at least some of the least significant bit groups to binary values, the conversion of each least significant bit group using a binary representation of a fraction proportional to a value of the one or more least significant bits from the least significant bit group; and
adding the binary values to the quantized pixel values to produce the processed digital image.

11. The computer program product of claim 10, wherein the fraction used in converting the least significant bit groups to a binary value has a numerator equal to a value of the least significant bit and a denominator equal to 2^{x}, where x is number of digits in the least significant bits.

12. The computer program product of claim 10, wherein the fraction belongs to a Farey Sequence M and the binary representation comprises a concatenation of binary representations of neighboring fractions from at least one of the Farey sequences 0 through M−1, wherein M is a positive integer.

13. The computer program product of claim 10, wherein the operations of converting and adding comprise:
converting at least some of the least significant bit groups to a map of binary values using binary representations of fractions each proportional to the value of the corresponding least significant bits; and
adding the map of binary values to the quantized pixel values to produce the processed digital image.

14. The computer program product of claim 10, wherein the operations further comprise:
defining a path through a plurality of pixels in the first digital image;
mapping a first least significant bit group associated with a first pixel in the path to a binary representation of a fraction corresponding to the first least significant bit group; and
successively assigning bit values of the binary representation to a first sequence of corresponding pixels along a corresponding path to produce the map of binary values.

15. The computer program product of claim 14, wherein the operations further comprise selecting a starting pixel in the path.

16. The computer program product of claim 14, wherein the path comprises a serpentine pattern or a Peano-Hilbert pattern in the first digital image.

17. The computer program product of claim 10, wherein the processed digital image is configured to be displayed by a display device comprising a liquid crystal display (LCD), a light emitting diode display (LED), an organic light emitting diode (OLED) display, a laser diode display, a projection display using a spatial light modulator, or a display device comprising a tiltable micro mirror.

18. A method for image processing, comprising:
quantizing pixel values of the first digital image to form a sequence of quantized pixel values each having the second bit depth, wherein quantizing the pixel values generates a sequence of least significant bit groups, each of the least significant bit groups including one or more least significant bits removed from an associated pixel value of the first digital image;
converting at least some of the least significant bit groups to binary values, the conversion of each least significant bit group using a binary representation of a fraction proportional to a value of the one or more least significant bits from the least significant bit group; and
adding the binary values to the quantized pixel values to produce the processed digital image.

19. The method of claim 18, wherein the fraction used in converting the least significant bit groups to a binary value has a numerator equal to a value of the least significant bit and a denominator equal to 2^{x}, where x is number of digits in the least significant bits.

20. The method of claim 18, wherein the fraction belongs to a Farey Sequence M and the binary representation comprises a concatenation of binary representations of neighboring fractions from at least one of the Farey sequences 0 through M−1, wherein M is a positive integer.

21. The method of claim 18, wherein the steps of converting and adding comprise:
converting at least some of the least significant bit groups to a map of binary values using binary representations of fractions each proportional to the value of the corresponding least significant bits, and
adding the map of binary values to the quantized pixel values to produce the processed digital image.

22. The method of claim 18, further comprising:
defining a path through a plurality of pixels in the first digital image;
mapping a first least significant bit group associated with a first pixel in the path to a binary representation of a fraction corresponding to the first least significant bit group; and
successively assigning bit values of the binary representation to a first sequence of corresponding pixels along a corresponding path to produce the map of binary values.

23. The method of claim 22, further comprising selecting a starting pixel for the path.

24. The method of claim 22, wherein the path comprises a serpentine pattern or a Peano-Hilbert pattern in the first digital image.

25. The method of claim 22, wherein the path passes all the pixels in the first digital image.

26. A method for processing a data string, comprising:
quantizing binary numbers in a first data string to form a quantized data string and a second data string that is a difference between the first data string and the quantized data string;
converting a first binary number in the second data string to a first transformed binary number using a binary representation of a fraction proportional to the first binary number; and
sequencing bit values of the first transformed binary number to form a first segment of a third data string.

27. The method of claim 26, wherein the step of converting comprises mapping the first binary number in the second data string to a fraction having a numerator equal to the value of the first binary number and a denominator equal to 2^{x}, where x is the bit depth of the second data string.

28. The method of claim 26, wherein the fraction belongs to a Farey Sequence M and the binary representation comprises a concatenation of binary representations of neighboring fractions from at least one of the Farey sequences 0 through M−1, wherein M is a positive integer.

29. The method of claim 26, further comprising adding the third data string to the quantized data string to produce a processed data string.

30. The method of claim 26, wherein the step of converting comprises selecting a start fraction in the second data string.

31. An image rendering method, comprising:
storing one-to-one mapping between a plurality of fractions to a plurality of binary representations;
converting a pixel value in a first digital image to a fraction proportional to the pixel value; and
mapping the fraction to one of the plurality of binary representations using the one-to-one mapping.

32. The image rendering method of claim 31, wherein the step of converting and mapping comprise:
converting each pixel value in a first digital image to a fraction proportional to the pixel value;
mapping the fraction to one of the plurality of binary representations using the one-to-one mapping; and
forming a second digital image comprising pixel values in one or more of the plurality of binary representations.

33. The image rendering method of claim 31, wherein the fraction used has a numerator equal to the pixel value and a denominator equal to 2^{x}, where x is the bit depth of the first digital image.

34. The image rendering method of claim 31, wherein the fraction belongs to a Farey Sequence M and the binary representation comprises a concatenation of binary representations of neighboring fractions from at least one of the Farey sequences 0 through M−1, wherein M is a positive integer.
